(19) United States
(12) Patent Application Publication
(10) Pub. No.: US 2006/0159269 A1
(43) Pub. Date: Jul. 20, 2006

(54) Cryptographic system for resource starved CE device secure upgrade and re-configuration

(75) Inventors: David Alan Braun, Denville, NJ (US); Gregory M. Perkins, Pennington, NJ (US)

Correspondence Address: RATNERPRESTIA, P O BOX 980, VALLEY FORGE, PA, 19482-0980, US

(73) Assignee: Matsushita Electric Industrial Co., Ltd.

(21) Appl. No.: 11/038,719

(22) Filed: Jan. 20, 2005

(51) Int. Cl. H04L 9/00

(52) U.S. Cl. 380/277

(57) ABSTRACT

A system for key management and securing communications channels is presented for the upgrade of compact electronic devices via a communications channel by service providers such as the original manufacturer and, possibly, a number of authorized third party service providers. The manufacturer, acting as a trusted authority, generates and distributes private cryptographic keys to each one of the clients and authorized service providers. The trusted authority also makes available public key values that may be used to secure communications between service providers and clients. The trusted authority may add additional authorized service providers and may also revoke the authorization of compromised service providers, thereby preventing communications between clients and said compromised service providers. Accordingly, authorized service providers, in addition to the manufacturer, may provide program and security upgrades, messages, and generally any data to electronic devices via a secure communications link.

### TECHNICAL FIELD

The present invention relates generally to a key management system and, more particularly, to a system and method of securing transmissions among a trusted authority, one or more service providers, and one or more client devices.

### BACKGROUND OF THE INVENTION

Conventional symmetric cryptographic algorithms allow pairs of users, who each share a common secret key, to exchange private messages even when communicating over a public network. Such systems possess very fast software implementations, inexpensive and fast hardware implementations, and, most importantly, are very secure. In fact, their security simply relies on one-way functions: functions f that are easy to evaluate but hard to invert, that is, for which it is hard, given a generic value z=f(x), to find any value y such that f(y)=z. Block ciphers such as DES, for example, are based on Fiestal networks and are invertible. One-way hash functions are one-way (and thus not invertible), as they are a many to one mapping. The security of symmetric cryptographic methods results from their output being nearly indistinguishable from a randomly generated output.

Despite these main advantages, conventional symmetric cryptosystems, however, are not very useful for large-scale communications platforms in which a plurality of users require secured communication with each other. Prior exchange of a common secret key (e.g., by physically meeting in a secure location) with every person with whom one wants to communicate in private is cumbersome in most scenarios.

To overcome this difficulty, several asymmetric cryptographic methods have been developed that allow two people to agree on common secret keys in a convenient manner. Asymmetric cryptographic methods are far more expensive computationally than symmetric cryptographic methods. Unfortunately, until now all publicly known protocols for this task are either based on the assumed computational difficulty of a particular number theory problem (as in the Diffie-Hellman and RSA algorithms), or they rely on a non-realistic amount of trust.

In the case of RSA, the encryption function f(x) typically is x^{e} mod n, where n is a publicly-known product of two large prime integers P₁ and P₂ (known only to the user who publishes n and e), and e (a publicly known exponent relatively prime with P₁ and P₂). In the RSA system, if a user X publishes two values e and n as above, then user Y can select a secret key k in an arbitrary manner and communicate it privately to X, by looking up X's publicized values, computing k′=k^{e} mod n, and sending k′ to X over a public network. If it is virtually impossible to calculate the e^{th}-root-modulo a composite integer the factorization of which is not known then only user X will be capable of retrieving k from k′; in fact, only X knows n's factorization (i.e., P₁ and P₂), and this knowledge makes extracting e roots feasible, though not trivial.

In the case of the Diffie-Hellman scheme, the protocol has two system parameters p and g. They are both public and may be used by all the users in a system. Parameter p is a prime number and parameter g (usually called a generator) is an integer less than p, where for every number n between 1 and p−1 inclusive, there is a power k of g such that n=g^{k} mod p.

Suppose Alice and Bob want to agree on a shared secret key using the Diffie-Hellman key agreement protocol. They proceed as follows: First, Alice generates a random private value a, and Bob generates a random private value b. Both a and b are drawn from the set of integers. Then they derive their public values using parameters p and g and their private values. Alice's public value is g^{a} mod p and Bob's public value is g^{b} mod p. They then exchange their public values. Finally, Alice computes g^{ab}=(g^{b})^{a} mod p, and Bob Computes g^{be}=(g^{a})^{b} mod p. Since g^{ab}=g^{ba}=k, Alice and Bob now have a shared secret key k.

The protocol depends on the Discrete Logarithm Problem for its security. It assumes that it is computationally infeasible to calculate the shared secret key k=g^{ab} mod p given the two public values g^{a} mod p and g^{b} mod p when the prime p is sufficiently large. It has been shown that breaking the Diffie-Hellman protocol is equivalent to computing discrete logarithms under certain assumptions.

However, the Diffie-Heliman key exchange is vulnerable to a man-in-the-middle attack. In this attack, an opponent Carol intercepts Alice's public value and sends her own public value to Bob. When Bob transmits his public value, Carol substitutes it with her own and sends it to Alice. Carol and Alice thus agree on one shared key and Carol and Bob agree on another shared key. After this exchange, Carol simply decrypts any messages sent out by Alice or Bob, and then reads and possibly modifies them before re-encrypting with the appropriate key and transmitting them to the other party. This vulnerability is present because Diffie-Hellman key exchange does not authenticate the participants.

In both the RSA and the Diffie-Hellman algorithms, however, the operations involved for secret-key exchange are quite time-consuming in software (computations of the type ab mod c are not-trivial whenever these values are large), or they require complex and expensive VLSI chips for fast modular exponentiation. Thus, building large-scale systems having efficient secret-key exchange using such techniques may require a great financial investment.

More importantly, the assumptions of the above secret-key exchange schemes to ensure security are very rigid. In the case of RSA, secret-key exchange is performed by means of an encryption function, f(x)=x^{e} mod n, which possesses a secret (i.e., the factorization of n) that, if known, makes the inversion of f (i.e., computing x from f(x)) possible rather than practically impossible. While it is widely believed that one-way functions exist, fewer researchers believe that one-way functions possess this additional property. Similarly, in the case of Diffie-Hellman, g^{x} mod p not only needs to be one-way, but it should also possess additional algebraic and multiplicative properties. Again, few people believe that one-way functions satisfying such additional algebraic constraints exist. Indeed, continuous algorithmic advances are being made that make factoring integers and solving the Discrete Logarithm Problem easier.

The methods described above do not provide a computationally efficient means to achieve secret-key exchange. Other algebraic secret-key exchange schemes have been devised by Blom and by Blundo et al., but these schemes rely upon an unrealistic amount of trust. In fact, not only do these schemes require a central authority that knows all the individual secret keys of the users, but also require that all of the users in a large system are trustworthy. For instance, in Blom's case, as described in an article titled “An Optimal Class of Symmetric Key Generation Systems,”Advances in Cryptology: Proceedings of Eurocrypt 84,Lecture Notes in Computer Science, Vol. 209, Springer-Verlag, Berlin, 1985, pp. 335-338, a trusted authority prepares and distributes keys to a group of n users. All these keys will remain secret, unless k of the users collaborate and reveal to each other the keys in their possession. If this happens, they can compute the secret keys of every other user in the system.

Moreover, with such schemes a few bad users may achieve the same results as a larger number of bad users by forcing good users to surrender their own secret keys. While in other schemes forcing some users to reveal their own keys may allow an enemy to understand at most the communications of those users (who will be aware of having lost privacy), in these algebraic schemes an enemy who has forced a sufficient number of users to reveal their own secret keys will understand the communications of all users, which is obviously unacceptable.

In another embodiment of the prior art, the RSA public key system may be used for secret key exchange. Briefly, the RSA public key system defines a private key sₚᵣ and a public key sₚᵤ. Private key sₚᵣ is used to sign messages, where the public key sₚᵤ is used to verify the signature. Messages may then be transmitted securely with encryption using the public key, E(message, sₚᵤ) where E(x,y) is an encryption operation that encrypts a value x with a key y. The message may then be decrypted using the private key by computing D(E(message, sₚᵤ),sₚᵣ), where D(x,y) is a decryption operation that decrypts a value x with a key y. Therefore, only the holder of the private key can decrypt documents encrypted with its corresponding public key. Accordingly, a user can create a private-public key pair (sₚᵣ, sₚᵤ) and make sₚᵤ public so that anyone can send encrypted documents securely to the user or verify the user's signature. Keeping sₚᵤ in a publicly available location presents a problem, however, in that a malicious user may replace sₚᵤ with its own public key aₚᵤ, and perform a man-in-the-middle attack to intercept encrypted documents. Furthermore, RSA implementations are computationally expensive and may require a large hardware footprint (e.g., about 150 k gates for 512 bit RSA keys).

In summary, therefore, the prior art techniques described above are often inadequate for secret-key exchange systems to be used on resource-starved devices, such as compact electronic devices. As a result, it may not be viable to secure communication links between service providers and compact electronic devices for the purpose of upgrading or, generally, communicating with the devices. The RSA and Diffie-Hellman cryptographic systems described above, for example, require expensive computing power in order to be implemented. As a result, they may not be viable options for implementation in compact or consumer electronics.

Other systems have been developed that utilize a trusted authority to disseminate secret keys to members of a group that wish to communicate securely between each other. Such systems, however, may not be scalable. Additionally, an untrustworthy member may compromise such systems if the member makes public the secret keys given to it by the trusted authority.

### SUMMARY OF THE INVENTION

The present invention is embodied in a method for initializing a public key system utilizing a symmetric encryption algorithm (i.e., symmetric public key system, or S-PKS) symmetric algorithm based public key system for use between one or more clients and one or more service providers. The method generates and stores one or more client private key values and identifiers and distributes each of the client private key values and identifiers to a respective one of one or more clients. The method also generates and stores one or more service provider private key values and identifiers and distributes the service provider key values and identifiers to respective ones of one or more service providers. The method generates one or more public key values for at least some pairings of the one or more service providers and the one or more clients and exclusive of pairings of one service provider with another service provider and one client with another client.

One aspect of the invention is embodied in a method of initializing a public key between a service provider and a client, for subsequent secure transfers of data from the service provider to the client, the data being encrypted with at least a session key. At initialization, the client receives a transmission from a service provider including a service provider identifier and an encrypted session key. The client then requests authentication of the service provider from a trusted authority. In one embodiment of the invention, this request is made at least once for each service provider-client pair. If the authentication information is invalid the client aborts the transfer. If the authentication information is valid, the client continues the transfer by obtaining, from the trusted authority (TA), a public key for communicating with the service provider, and decrypting at least a portion of the transmission from the service provider using the public key supplied by the TA and a private key held by the client to obtain the session key. The client then receives the transferred file and decrypts it using the session key.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a public key table, according to the prior art;

FIG. 2 is a block diagram of a system according to one embodiment of the present invention;

FIG. 3 is a flow-chart of an exemplary method of initializing a cryptographic system, according to one embodiment of the present invention;

FIG. 4 is a public key table, according to an embodiment of the present invention;

FIG. 5A is a block diagram of a system according to another embodiment of the present invention;

FIG. 5B is a public key table, according to the embodiment of the present invention as illustrated in FIG. 5A;

FIG. 6 is a block diagram illustrating three layers of security provided by one embodiment of the present invention;

FIG. 7A is a flow-chart illustrating a method of authenticating public keys according to one embodiment of the present invention;

FIG. 7B is a flow-chart illustrating another method of authenticating public keys according to another embodiment of the present invention; and

FIG. 8 is a block diagram illustrating a further cryptographic system, according to the present invention.

### DETAILED DESCRIPTION OF THE INVENTION

In their patent entitled “Method for Enabling Users of a Cryptosystem to Generate and Use a Private Pair Key for Enciphering Communications between the Users”, U.S. Pat. No. 5,519,778, Leighton and Micali disclose a method wherein a trusted agent distributes, in some secure way, a secret key unique to each member of a group of users. The trusted authority then generates an n-by-n table of symmetric public keys, where n is the number of users in the group. The columns and rows of the table are labeled with an ordered list of the unique identifying names of the members of the group. According to the Leighton-Micali method, the table of public keys is placed in a public, tamper resistant location and the trusted authority is destroyed. The public key values in the table may then be used by users in the group to initiate secure communications, as described below, with other group members.

The Leighton and Micali system may be considered as being one form of a Symmetric Algorithm Based Public Key System (S-PKS). Generally, a S-PKS may be initialized by a trusted authority and may comprise a plurality of users, each having an identifier and a secret key known only to the user. Any two users in such a system may initiate a secure connection by computing a bi-directionally symmetric public key to negotiate a session key value, where each user has no knowledge of the other user's secret key. Once a session key has been negotiated, all further messages between the users may be encrypted using the session key. While the Leighton and Micali method qualifies as being a S-PKS, it is contemplated that other S-PKS systems, methods, protocol, and/or algorithms may be used in the present invention as a means for securing the communications medium between users in the system. The communications medium may be any one of a wired local area network, a wireless local area network, a secure digital card, a portable storage device, an infrared channel, a satellite link, a fiber optic link, or a cable link.

According to one embodiment of the present invention, each group member 1, 2, 3, ... and n may be identified by a respective identifier α₁, α₂, α₃, . . . αₙ and may be given a respective secret key s₁, s₂, s₃, . . . sₙ by a trusted authority. The trusted authority then computes a public key p_{i,j} that may be used, as described below, to secure connections between any two users in the group, such as αᵢ having secret key sᵢ and αⱼ having secret key sⱼ, for example. The public key may be computed using the following formula:
P_{i,j}=E(αᵢ,sⱼ)⊕E(αⱼ,sᵢ)

Where E(x,y) is an encryption operation (e.g., a block cipher or a keyed one-way hash function) that encrypts an input value x with a cryptographic key value y, and ⊕ is the Exclusive-OR operation. Those skilled in the art will recognize that such a method allows the use of symmetric algorithms in place of asymmetric algorithms, while supporting an asymmetric public key infrastructure. Accordingly, fast cryptographic algorithms such as block ciphers, for example, may be utilized for encryption operations, thereby using few resources in both hardware and software.

In one embodiment of the Leighton and Micali method, the trusted authority may populate and make available a public key table with public keys for all user combinations in the group, and the trusted authority may thereafter be destroyed. In such an embodiment, the trusted authority may provide and populate the public key table with additional authentication data for each of the public keys, thereby allowing clients to authenticate the public key upon download from the table. Accordingly, the public key table need only be kept tamper-proof, since adequate security may be provided by the authenticating data.

Alternately, the trusted authority may compute a public key on demand for each pair of users that attempt to establish secured communications by sending a request to the trusted authority for their corresponding public key. For this alternate it is desirable for the trusted authority be highly secure.

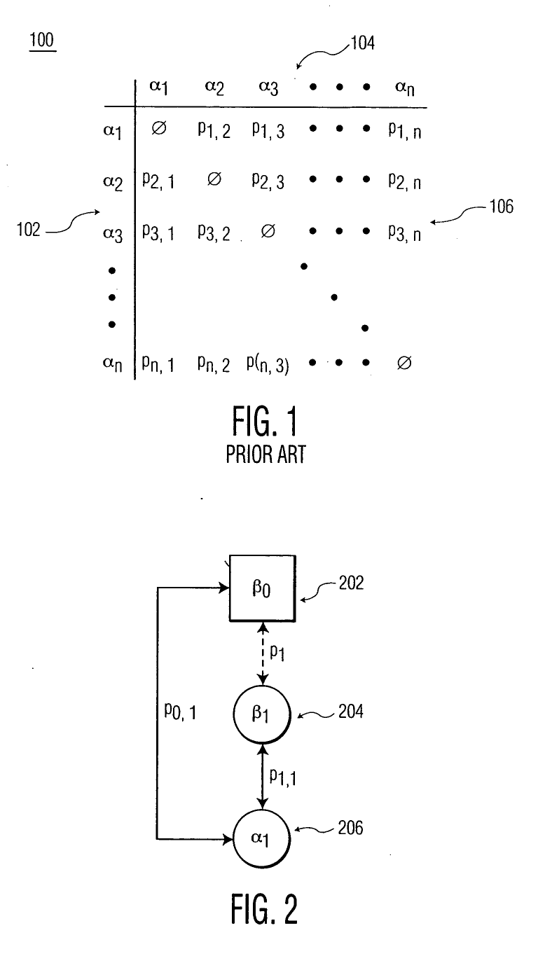

FIG. 1 shows an exemplary public key table 100 that may be referred to by users in a group attempting to establish secured communications. The public key table 100 includes column headers 104 and row headers 102 containing user identifiers α₁, α₂, α₃, . . . αₙ, where each user identifier uniquely identifies a member of the group. Public key table 100 further contains public key array 106 including a plurality of public keys (and, in one embodiment, their corresponding authentication data—not shown in FIG. 1), where each public key corresponds to a unique pairing of two members of the group and is calculated as described above.

Referring now to the drawing, in which like reference numbers refer to like elements throughout the various figures that comprise the drawing, FIG. 2 is a block diagram illustrating one embodiment of the present invention as a public key cryptography system comprising a trusted authority 202 having a trusted authority identifier β₀ and a trusted authority secret key t₀ (not shown in FIG. 2), a service provider 204 having a service provider identifier β₁ and a service provider secret key t₁ (not shown in FIG. 2), and a client 206 having a client identifier α₁ and a client secret key s₁ (not shown in FIG. 2).

In the exemplary embodiment, trusted authority 202 initializes the public key cryptography system, which may include generating and securely providing service provider 204 with the service provider identifier β₁ and the service provider secret key t₁, and client 206 with the client identifier α₁ and the client secret key s₁.

Trusted authority 202 may also generate and make available public key values for securing communications between the service provider and the client, as described above. The public key values may be stored in a public key table, or may be generated on demand by sending a request to the trusted authority. Accordingly, trusted authority 202 may secure communications with client 206 with use of public key p_{0,1}, as described below. Additionally, service provider 204 may secure communications with client 206 with use of public key p_{1,1}. In one embodiment of the invention, it may also be desirable to provide a public key p₁ to use in securing communications between service provider 204 and trusted authority 202. According to this embodiment, the trusted authority may distribute device upgrades to the service provider, and the service provider may then distribute the device upgrades to the one or more clients it is responsible for.

Trusted authority 202 may take appropriate measures to provide a desirable level of security in distribution of the client and service provider secret keys, and may, for example, physically transport the secret key data to the individual clients and service providers. Those skilled in the art will recognize that there are many methods of secret key distribution that may be used to provide various desirable levels of security without departing from the present invention.

In the exemplary embodiment of the present invention, the trusted authority performs initialization tasks that setup the cryptographic system for use by service providers and clients. In a further embodiment, the trusted authority may, after initialization, continue to perform various maintenance tasks, which may include, for example: adding additional authorized clients and/or service providers to the system as well as their corresponding additional public keys to the public key table; removing compromised clients and/or service providers from the system as well as their corresponding public keys from the public key table; responding to clients that request authentication of certain service providers; initiating secure communications with clients to update their secret keys and/or to securely transmit software and device upgrades; and initiating secure communications with service providers to update the service provider secret keys.

In the exemplary embodiment illustrated in FIG. 2, service provider 204 may securely distribute software and device upgrades to client 206 after negotiating a session key with client 206 using public key p_{1,1}. In a further embodiment, a plurality of service providers may be provided to distribute software and device upgrades to a plurality of clients. Software and device upgrades may include, for example, updates, fixes, and/or service packs for firmware, middleware, device drivers, and/or application software.

In one embodiment of the present invention, the trusted authority may be the manufacturer of a large number of compact electronic devices (i.e., clients) that may contain device drivers and application software, for example. The manufacturer, acting as a lone trusted authority, may not be able to afford the resources necessary to provide the large number of electronic devices with necessary device upgrades in a timely fashion. Consequently, it may be desirable for the manufacturer to give each one of a plurality of 3^{rd} party service providers the authority to provide upgrades to at least some of the large number of electronic devices by providing each service provider with a secret key, and generating public key values as described above to allow the providers to secure communications with the devices, as described below.

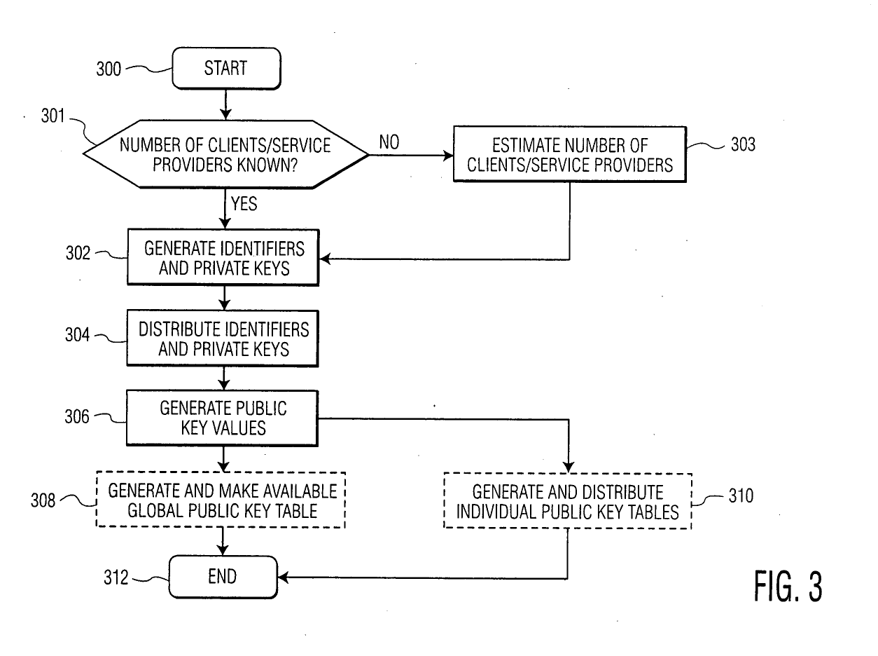

FIG. 3 is a flow chart illustrating a method for initializing a cryptographic system according to one embodiment of the present invention. The method starts at step 300, and proceeds to step 301, which determines the number of clients and/or service providers that are to be added to the system. If the number is not known, then step 303 estimates the number of clients and/or service providers that are expected to be a part of the system. Once an initially predetermined number of clients and/or service providers is established, the method may proceed to step 302 to generate unique identifiers and private cryptographic key values for each one of the predetermined number of service providers and clients. In step 304, the respective identifiers and keys are securely distributed to each of the service providers and clients. In one embodiment, the identifiers and private keys for the clients may be generated and concurrently distributed while the clients are being manufactured in a manufacturing facility, for example, where the manufacturer may act as a trusted authority. Additionally, the manufacturer acting as the trusted authority may generate and distribute identifiers and keys to the one or more service providers at a desirable time before or after distribution of identifiers and private keys to the one or more clients.

In step 306, a public key for each service provider-client pair may then be generated, as described above, wherein the public key may be used in enabling a service provider to initiate secure communications with a client, as described below. Those skilled in the art will recognize that, while shown sequentially in FIG. 3, the generation of public key values may be performed at any point in the initialization process once the identifiers and private keys have been generated for at least some of the service providers and clients. Alternately, the service provider identifiers and private keys may be generated in advance of the client identifiers and private keys, and step 306 may be performed immediately after every client identifier and private key that is generated and/or distributed. Additionally, in one embodiment, there may be a large number of clients and it may therefore be desirable to group a predetermined number of clients into one or more client lots, wherein each client lot is given a unique identifier and private key. As such, each group of the predetermined number of electronic devices may be considered as constituting a single client, as opposed to a client lot. Accordingly, a public key value for the combination of a service provider and a particular client may be used to secure communications with each one of the predetermined number of electronic devices that correspond to the particular client.

Continuing in the flow-chart of FIG. 3, after the public key values have been generated, one embodiment of the invention may proceed to step 308 to generate and make available a global public key table containing the public keys for all of the service provider-client combinations. Alternately, the initialization process may proceed to step 310 where individual public key tables are generated and distributed. In one embodiment, the individual public key tables may include public key values generated for pairings of a particular service provider and all of the clients for which the particular service provider is authorized to provide upgrades (i.e., individual service provider public key tables). The individual public key table may then be distributed to the service provider, which may use the appropriate public keys in securing communications with clients. In an alternate embodiment, the individual public key tables may include public key values generated for pairings of a particular client and all of the service providers from whom the client is authorized to receive upgrades (i.e., individual client public key tables). The individual public key table may then be distributed to the client, which may use the appropriate public keys in securing communications with service providers.

Once the unique identifiers, cryptographic key values, and public key values have been generated and desirably distributed, the initialization process may end in step 312.

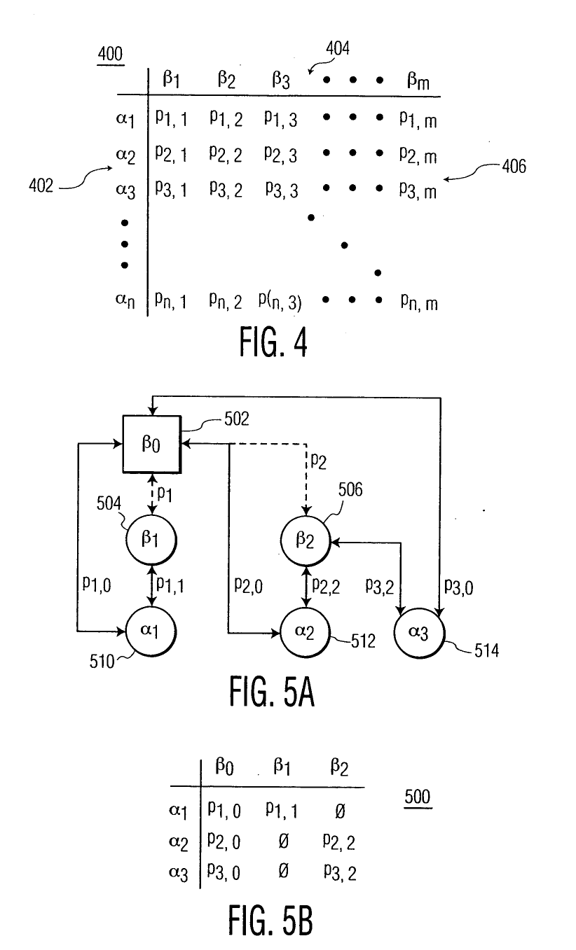

FIG. 4 illustrates an exemplary global public key table 400 containing public keys 406 described above. Accordingly, public key table 400 contains service provider identifiers β₁, β₂, β₃ . . . βₘ arranged as column headers 404, and client identifiers α₁, α₂,α₃, . . . αₙ arranged as row headers 402. Furthermore, public keys p_{1,1}, p_{2,1}, p_{3,1}, p_{n,1} are provided for use in securing communications between a first service provider β₁ and clients α₁ through αₙ, as described below. The remaining public keys shown are provided for use in securing communications between the remaining service providers β₂ through βₘ and clients α₁ through αₙ. The public key table may be managed and made available by a trusted authority. Alternately, each service provider or client may be given an individual public key table containing a list of client or service provider identifiers, respectively, and associated public key values, as described above (e.g., service provider β₁ is provided with client identifiers α₁ . . . αₙ and corresponding public keys p_{1,1} . . . p_{n,1}, and/or client α₁ is provided with service provider identifiers β₁ . . . βₘ and corresponding public keys p_{1,1} . . . p_{1,m}). This would correspond to each client receiving a respective row of table 400 in FIG. 4 (e.g., client α₁ receiving row 1), and each service provider receiving a respective column (e.g., service provider β₁ receiving column 1).

Additionally, the method shown in FIG. 3 may include steps to generate a trusted authority identifier β₀ and cryptographic private key t₀, if desirable. Furthermore, additional public key values (not shown in FIG. 4) for the trusted authority may be added to the public key table of FIG. 4 under an extra column containing column header β₀ (not shown in FIG. 4). In a further embodiment, the trusted authority may also generate and separately store public key values for securing communications between itself and the service providers. The additional private key value and additional public key values described above allow the trusted authority to securely communicate with clients and service providers, allowing a manufacturer to transmit security upgrades and updates directly to clients or service providers, for example.

Those skilled in the art will recognize that while the embodiments of the invention described above include service providers that are able to secure communications with all of the clients in the system, many other management hierarchies may be employed without departing from the present invention. FIG. 5A, for example, is a block diagram illustrating an exemplary alternate embodiment of the present invention. The alternate embodiment includes trusted authority 502 having a trusted authority identifier β₀ and a trusted authority secret key t₀ (not shown in FIG. 5A), service providers 504 and 506 having respective service provider identifiers β₁ and β₂ and service provider secret keys t₁ and t₂ (not shown in FIG. 5A), and clients 510, 512, and 514 having respective client identifiers α₁, α₂, and α₃ and client secret keys s₁, s₂, and s₃ (not shown in FIG. 5).

In the alternate exemplary embodiment, trusted authority 502 initializes the public key cryptography system by generating and securely providing the client and service provider identifiers and secret keys, as described above. In the alternate exemplary embodiment, however, it is desired that service provider 504 only be able to communicate with client 510 and service provider 506 only be able to communicate with clients 512 and 514. Consequently, trusted authority 502 only generates and makes available public key values for securing communications between the authorized parties. The corresponding public key values may be stored in global public key table 500 (shown in FIG. 5B), individual public key tables (not shown in FIGS. 5A and 5B), or may be generated on demand by transmitting a request to the trusted authority (i.e., a public key lookup service).

Accordingly, trusted authority 502 may secure communications with client 510 using public key p_{1,0}, with client 512 using public key p_{2,0}, and with client 514 using public key p_{3,0}. Additionally, service provider 504 may secure communications with client 510 with use of public key p_{1,1}, while service provider 506 may secure communications with clients 512 and 514 using public keys p_{2,2} and p_{3,2}, respectively. In one embodiment of the invention, it may also be desirable to provide public keys p₁ and p₂ to use in securing communications between trusted authority 502 and service providers 504 and 506, respectively. Accordingly, a public key table made available in an exemplary limited accessibility system, such as the one described, may not contain public key values for unauthorized pairings of service providers and clients, as described above, thereby precluding secure communication between such unauthorized pairings.

In an embodiment of the present invention, a trusted authority performs the initialization tasks described above, and locally stores all of the identifiers and private keys for the clients and service providers in a secure location. The trusted authority may also securely store the corresponding public key values. Additionally, the trusted authority may continue to perform certain maintenance tasks such as adding additional authorized clients and/or service providers to the system in addition to generating corresponding additional public keys, which may be added to the public key table.

If the trusted authority has secure access to all of the identifiers and private keys for the users of the cryptographic system (i.e., clients and service providers), then it may add additional clients and/or service providers to the system by generating additional, unused identifiers and private keys for the additional clients and/or service providers. The trusted authority may also generate additional public key values corresponding to authorized pairings of the new clients with the old service providers and the new service providers with the old clients; public key tables may also be desirably augmented to include the additional information. If the cryptographic system employs individual public key tables, as described above, then the trusted authority may send a new individual public key table containing the additional information to the party hosting the individual public key table (e.g., client or service provider). Alternately, the trusted authority may send only the additional information to the party hosting the individual public key table, whereby the party may augment its existing public key table to include the additional information.

An additional maintenance task may include removing compromised clients and/or service providers from the system as well as their corresponding public keys from the public key table. Compromised service providers may include, for example, service providers that have allowed their private cryptographic key to be made public, thereby presenting malicious agents with the opportunity to assume the identify of the service provider and thereby send malicious upgrades and code to clients in the system. Compromised service providers may also include 3_{rd} party service providers with whom the manufacturer no longer does business or, otherwise, any service provider the trusted authority wishes to remove from the system. Once a compromised service provider has been identified, therefore, the trusted authority may take one or more precautions to prevent clients from communicating with the compromised service provider.

In an alternate embodiment, the trusted authority may update the private cryptographic key of a compromised service provider to a new private key. In such an embodiment, every service provider may be provided with a second private cryptographic key for key updates in addition to the private key. Accordingly, the second private cryptographic key may be a longer key, use stronger encryption, and/or be located in a secure location separate from the private key. Therefore, when a service provider is compromised and its private key is stolen, for example, the trusted authority may securely transmit a new private key and instruct the service provider to delete the old private key and replace it with the new private key. The new private key may be transmitted by securing a connection between the trusted authority and the service provider using a public key value generated, as described above, based on a trusted authority private key and the service provider's second private key. Alternately, the trusted authority may directly encrypt the new private key using the service provider's second private key. Finally, new public keys (and, in some embodiments, corresponding authentication data) for the new service provider private key are desirably generated and distributed by the trusted authority.

In systems where clients obtain public key values from the trusted authority (e.g., from a global public key table administered by the trusted authority or an on-demand calculation of the public key by the trusted authority), certain precautions may be taken by the trusted authority to preclude communication between the clients and a compromised service provider. As one precaution, the trusted authority may remove the compromised service provider from the global public key table or refrain from providing a public key to clients attempting to communicate with the compromised service provider, thereby preventing clients from being able to obtain a public key value to initiate a secure connection with the compromised service provider. Accordingly, clients that aren't able to establish a secure connection with a service provider may refrain from communicating with the service provider. Additionally, clients that request an on-demand public key calculation for establishing secure communication with-a compromised service provider may be sent a message from the trusted authority instructing the clients not to communicate with the compromised service provider.

Alternately, the trusted authority may reuse the identifier associated with a compromised service provider for a newly authorized service provider. Since the newly authorized service provider will have a different private key value than the compromised service provider, the trusted authority will also replace public key values associated with the compromised service provider with new values associated with the newly authorized service provider. Accordingly, the compromised service provider will not be able to initiate secure communications with the clients, since the new public key values will be incompatible with the compromised service provider. The methods described above may also be used to isolate compromised clients from the cryptographic system.

As a precaution in a further embodiment, the trusted authority may remove compromised service providers from a list of authorized service providers (i.e., a white list) and/or add them to a list of unauthorized service providers (i.e., a black list); the trusted authority may then require clients to consult one or more of these lists prior to communicating with any service providers, thereby precluding communications between clients and the listed compromised service providers, while allowing communications between clients and authorized service providers.

As yet another precaution, the trusted authority desirably transmits an alert to at least some of the clients, wherein the alert may instruct the clients to ignore communications from compromised service providers and may include the identifiers of the compromised service providers as identifying information, for example.

In another embodiment of the invention, a further maintenance task of the trusted authority may include securely retiring and upgrading client private key values. In one embodiment, the trusted authority may provide each client with a second secret key value that may be used solely for initiating secure connections with the trusted authority to retire and replace the private key value. The second key value may be longer than the private key value and may use an alternative keyed hash function for added security. The second key value is desirably cryptographically stronger, and the added computational costs may be acceptable, since client key upgrade may occur less often than other client upgrades. Accordingly, once a secure connection is negotiated between the trusted authority and a client using the second key value, the trusted authority may transmit the new private key value to the client in addition to a command to delete the old private key value and replace it with the new one.

In an alternate embodiment, the trusted authority may preclude the implementation of a second key value and provide key upgrades described above through a connection secured using the client's old private key value. Such an embodiment may fail to curb the actions of a malicious user that is in control of the old client key, since the malicious user may use the old client key to obtain the new client key. However, such an embodiment does not introduce the additional overhead associated with the addition of a second secret key value, and may be desirable for typically often-occurring client security upgrades.

According to the present invention, a service provider having a service provider identifier β₁ and secret key t₁ may contact and subsequently attempt to initiate a secure connection with a client having a client identifier α₁ and a client secret key s₁, wherein the secure connection may be used to transmit secured upgrades to the client once the secure connection is established. Alternately, the client may transmit a request for upgrades to the service provider, whereby the service provider may then attempt to initiate a secure connection with the client. Those skilled in the art will recognize that the trusted authority may be considered as a service provider, but may have additional control over the system.

In order to initiate a secure connection, a public key corresponding to the client and service provider secret keys is obtained. Accordingly, the service provider obtains a symmetric public key p_{1,1} corresponding to its pairing with the client. The public key may be obtained from a global public key table, on demand from a trusted authority, through a transmission from the client, or from a locally stored individual public key table, for example. Furthermore, the public key may be calculated as:
P_{1,1}=E(α₁,t₁)⊕E(β₁,s₁),

where E(x,y) is an encryption operation (e.g., a block-cipher or a keyed one-way hash function, for example) that encrypts the value x with a key value y. The public key value above may be calculated and stored in a global public key table administered by a trusted authority, calculated and transmitted on demand by the trusted authority, or stored in a local memory of the client and/or the service provider.

The service provider may then identify itself to the client by transmitting service provider identifier β₁ in addition to a random variable X that may be used as a session key (i.e., to encrypt session traffic between the service provider and the client). The random variable X is encrypted prior to transmission, according to the following formula:
E(X, p_{1,1}⊕E(a₁,t₁,))

Alternately, a single transmission may be sent including information on both the service provider identifier and the session key:
E(β₁⊕X, p_{1,1}⊕E(α₁, t₁))

Additionally, the service provider may authenticate itself to the client by transmitting an encrypted value such as:
p_{1,1}⊕E(α₁,t₁)

The client may receive the encrypted value and may proceed to authenticate the service provider by obtaining the service provider identifier from the encrypted value:
p_{1,1}⊕E(α₁,t₁)=E(β₁,s₁)
E⁻¹(E(β₁, s₁), s₁)=β₁

If the expected identifier is not found from the above calculations, then the service provider is not authenticatable. The client may be reasonably certain of the validity of p_{1,1} as it may have been obtained through a secured encrypted transfer from the trusted authority, from a public key table with authenticating data, or installed in the client at the time of manufacture.

Either before or after authenticating the service provider, the client may access a list of unauthorized service providers (i.e., a black list) to see if it contains the service provider identifier β₁. In one embodiment, the client may transmit a secure request to a trusted authority for verification of the service provider as being an authorized service provider. Alternately, the trusted authority may periodically notify the client of compromised service providers, whereby the client may add the compromised service providers to unauthorized service providers list. The trusted authority knows the client secret key s₁, and may therefore pass a random session key to the client, thereafter encrypting transmissions to the client using the random session key and allowing the client to easily decrypt the transmissions. Alternately, the trusted authority may encrypt transmissions to the client according to the current embodiment of the invention being discussed.

If the service provider is identified as being a compromised service provider, the client may ignore future communications from the service provider and terminate current communications with the service provider. If the service provider is an acceptable service provider, however, the client may continue to obtain the session key by decrypting the encrypted transmission through the following calculations:
E(X,p_{1,1}⊕E(α₁,t₁,))=E(X, E(β₁,s₁))
E⁻¹(E(X, E(βhd 1,s₁)),E(β₁,s₁))=X

Once the random variable session key X is obtained, a secure session may be established, and all further messages between the service provider and the client may be encrypted as E(message,X). Alternately, the client may first be required to authenticate itself to the service provider once it has obtained the session key X by transmitting:
E(p_{1,1}⊕E(β₁,s₁), X)

The service provider may receive the above transmission and simplify it as:
E(E(α₁, t₁),X)

Accordingly, since the service provider has knowledge of the values X and t₁, it is, therefore, able to authenticate the client by performing two decryption operations on the above simplified transmission to obtain α₁; if α₁ is not obtained, the client is not authenticated. Once the session key has been negotiated, as described above, the service provider may encrypt session traffic—which may include upgrade packages, code and commands, for example (i.e., payload files)—with session key X and securely transmit to the client.

Furthermore, the service provider may use a hash function on the payload files to generate a hash value h bits long, where, in one embodiment, log₂(h)may be 128-256 bits. The client may then authenticate the payload files by computing the hash function on the received payload files and comparing the obtained hash value with the hash value sent by the service provider. If the hash values match, then the payload files are authenticated and may be decrypted and executed/installed. If the hash values do not match, then the client may request that the service provider re-send the payload files along with a new hash value, or the upgrade may be aborted altogether.

FIG. 6 is a block diagram illustrating three layers of security that may be implemented in one embodiment of the invention. The first layer of security is gained by encrypting session traffic 602 with session key X, as described above. Further, session traffic 602 includes a payload file 604 being delivered to a client from a service provider, and payload file 604 may be encrypted with a secret key P. Additionally, in order to provide a means for authenticating the payload file, the service provider may provide a hash file 606 generated from the payload file 604, as described above. The hash function is signed by a hash secret key S, and provides the third layer of security. Hash secret key S may be securely shared with the client using the same methods as described above for the session key X. Alternately, hash secret key S may be securely obtained, as described above, from a trusted authority or a different service provider. In one embodiment, hash file 606 may be obtained with a keyed non-compressing one-way hash function or, alternately, it may be omitted and the payload may be signed using a keyed compression one-way hash function.

In an alternate embodiment of the present invention, additional precautions may be taken to ensure the authenticity of the public key value. Accordingly, every service provider in the cryptographic system may be provided with two secret key values tⱼ and bⱼ, and every client in the cryptographic system may be provided with two secret key values sᵢ and cᵢ. The additional key values bⱼ and cᵢ may be considered as a service provider authentication key and a client authentication key, respectively. Furthermore, there may be three public key values associated with each pairing of a service provider and at least one client. The three public key values include the original p_{i,j}, described above, in addition to a client authentication public key value E(E(αᵢ,tⱼ)cᵢ) and a service provider authentication public key value E(E(βⱼ,sᵢ),bⱼ).

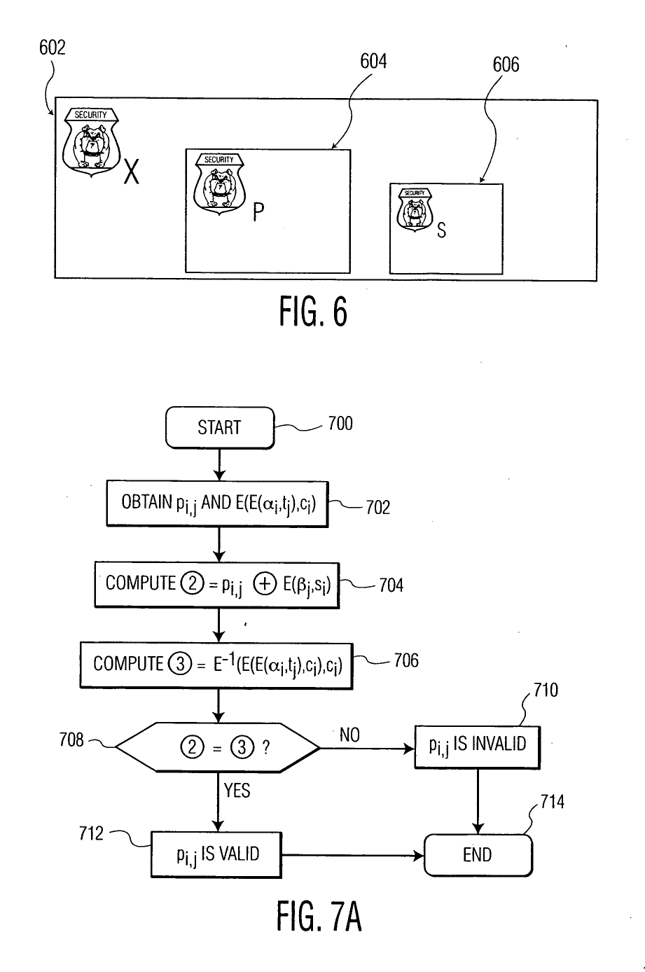

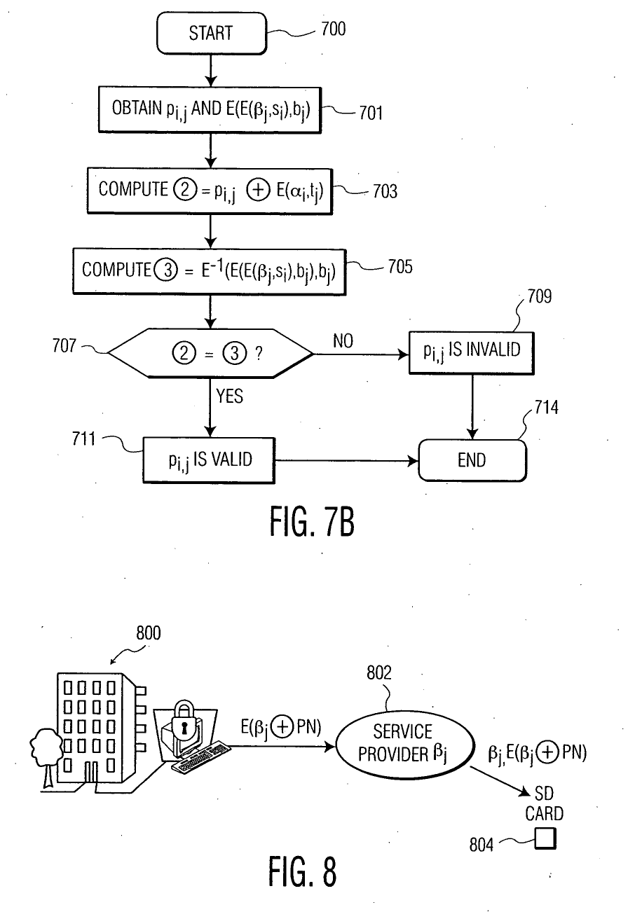

FIG. 7A is a flow-chart illustrating one method by which a client may authenticate the public key value p_{i,j}. The method starts with step 700 and proceeds to step 702 where the client obtains public key values p_{i,j} and E(E(αᵢ,tⱼ),cᵢ). The public key values may be obtained as previously described.

In step 704, the client computes:
=p_{i,j}⊕E(βⱼ,sᵢ)=E(αᵢ,tⱼ) \textcircled{2}

In step 706, the client computes:
=E⁻¹(E(E(αᵢ,tⱼ),cᵢ),cᵢ)=E(αᵢ,tⱼ) \textcircled{3}

If, in step 708, the client determines that the values computed for \textcircled{2} and \textcircled{3} are equivalent, then step 712 concludes that the public key value p_{i,j} is valid and may be used to secure a connection with the corresponding service provider. If the two values are not equivalent, then the client concludes in step 710 that the public key value p_{i,j} is invalid. The method ends in step 714.

Similarly, FIG. 7B is a flow-chart illustrating one method by which a service provider may authenticate the public key value p_{i,j}. The method starts with step 700 and proceeds to step 701 where the service provider obtains public key values p_{i,j} and E(E(βⱼ,sᵢ),bⱼ). In step 703, the service provider computes:
=p_{i,j}⊕E(αᵢ,tⱼ)=E(βⱼ,sᵢ) \textcircled{2}

In step 705, the service provider computes:
=E⁻¹(E(E(βⱼ,sᵢ),bⱼ),bⱼ)=E(βⱼ,sᵢ) \textcircled{3}

If, in step 707, the service provider determines that the values computed for \textcircled{2} and \textcircled{3} are equivalent, then step 712 concludes that the public key value p_{i,j} is valid and may be used to secure a connection with the corresponding client. If the two values are not equivalent, then the service provider concludes in step 710 that the public key value p_{i,j} is invalid.

Those skilled in the art will recognize that the present invention may allow clients to log information on transmissions received from service providers, upgrades provided by the service providers, and dates/times the service providers offered updates or made transmissions. Accordingly, with each upgrade, a client may store the supplying service provider's identifier, the date/time of upgrade, and any other relevant information on the upgrade, thereby keeping a comprehensive log of upgrades and communication that may be accessed for any future troubleshooting needs. The log may also be periodically transmitted to the trusted authority, so that the trusted authority may be able to detect any malicious or otherwise undesirable transmissions made by compromised service providers.

Accordingly, when the trusted authority receives such an indication that an existing service provider has been compromised, the trusted authority may revoke the authorization of the compromised service provider (e.g., by removing the public key values associated with the compromised service provider from the public key table, removing the compromised service provider from a white list, adding the compromised service provider to a black list, and/or transmitting a warning to clients not to communicate with the compromised service provider). The trusted authority may also replace the compromised service provider secret key with a new secret key. It is contemplated that the trusted authority may receive an indication that a service provider has been compromised in various other ways without departing from the present invention.

In a final embodiment, client upgrades may come from a local source such as a Secure Digital (SD) card, a Flash Drive, or a Memory Stick, for example. FIG. 8 illustrates such an embodiment, wherein trusted authority 800 transmits encrypted part number information, E(βⱼ⊕PN), for a local source (e.g., SD card) 804 that contains a payload for delivery to one or more client devices (not shown). Service provider 802 may receive the encrypted part number information from trusted authority 800, and encrypt the payload as E(Payload,βⱼ⊕PN) onto local source 804. Accordingly, client devices may have part number information on file for one or more authorized local sources, which may be referred to when attempting to decrypt the payload contained on a particular local source provided by a particular service provider. In this manner, local source 804 comes with signed authorization from trusted authority 800, thereby allowing a client (not shown) to preclude authentication steps.

Finally, those skilled in the art will recognize that a computer controller and memory devices may be implemented in one or more of the trusted authority, the service providers, and the clients for implementing embodiments of the invention, described above. Furthermore, the trusted authority, service providers, and clients may include receivers, transmitters, and/or transceivers for sending and receiving messages in a communications medium, as described above.

Although illustrated and described above with reference to certain specific embodiments, the present invention is nevertheless not intended to be limited to the details shown. Rather, various modifications may be made in the details within the scope and range of equivalents of the claims and without departing from the invention.

What is claimed is:

1. An asymmetric cryptographic key management system for secure data exchange using symmetric algorithms, the system comprising:
a plurality of clients, each client having a unique client identifier and client secret key;
one or more service providers for transmitting secure data to the plurality of clients, each service provider having a respective service provider identifier and service provider secret key;
a plurality of public key values, each public key value for securing a connection between at least one of the plurality of clients and one of the one or more service providers, exclusive of any other service provider of the one or more service providers;
a trusted authority for assigning the service provider identifier and service provider secret key for each of the one or more service providers, and for assigning the client identifier and client secret key for each of the plurality of clients, and the plurality of public key values, the trusted authority having a trusted authority identifier and a trusted authority secret key; and
one or more additional public key values, each additional public key value for securing a connection between the trusted authority and at least one of the clients.

2. A system according to claim 1, further comprising one or more further public key values, each further public key value for securing a connection between the trusted authority at least one of the one or more service providers.

3. A system according to claim 1, wherein each service provider has a second secret key for securely updating the service provider secret key.

4. A system according to claim 1, further comprising:
a plurality of client authentication keys;
a plurality of client authentication public key values, each client authentication public key value for authenticating a respective one of the plurality of public key values;
one or more service provider authentication keys; and
one or more service provider authentication public key values, each service provider authentication public key value for authenticating a respective one of the one or more public key values.

5. A system according to claim 1, further comprising at least one of:
a global public key table containing the plurality of public key values and the one or more additional public key values;
one or more individual service provider public key tables, wherein each individual service provider public key table is stored by a respective service provider and includes at least one public key value of the plurality of public key values for securing a connection between the respective service provider and at least one of the plurality of clients;
one or more individual client public key tables, wherein each individual client public key table is stored by a respective client and includes the one or more public key values for securing a connection between the respective client and at least one of the one or more service providers; and
a public key lookup service for obtaining at least one of the plurality of public key values by transmitting a request to the trusted authority.

6. A system according to claim 1, further comprising at least one of:
a white list including acceptable service provider identifiers of the one or more service provider identifiers; and
a black list including unacceptable service provider identifiers of the one or more service provider identifiers.

7. An asymmetric key management system that employs symmetric encryption algorithms for secure transmission of information, the system comprising:
a plurality of clients, each client having a unique client secret key value and identifier;
one or more service providers, each service provider having a unique service provider secret key value and identifier;
one or more public key tables, each public key table including
one service provider identifier for each of the one or more service providers,
a plurality of client identifiers, one for each of the plurality of clients, respectively, and
a plurality of public key values, wherein each of the plurality of public key values is assigned to a pairing of a respective one of the plurality of client identifiers and a respective one of the one or more service provider identifiers, exclusive of any other service provider of the one or more service provider identifiers; wherein
secure transmission of information is achieved between the one or more service providers and clients by negotiating a symmetric session key to encrypt communications.

8. A system according to claim 7, further comprising:
a trusted authority for updating keys for the plurality of clients, the one or more service providers, and for maintaining the one or more public key tables, the trusted authority including
a unique trusted authority secret key value and identifier, and
a memory for storing the plurality of client secret key values and identifiers, the one or more service provider secret key values and identifiers, and the one or more public key tables; and
one or more additional public key values, wherein each additional public key value of the one or more additional public key values is assigned to a respective pairing of the trusted authority identifier and a client identifier of the one or more client identifiers; wherein
at least one of the one or more public key tables includes the one or more additional public key values.

9. The system according to claim 7, further comprising a controller for implementing a symmetric algorithm based public key protocol to secure a communications channel with at least a symmetric session key.

10. The system according to claim 9, wherein the communications channel is established through one of a wired local area network, a wireless local area network, a secure digital card, a portable storage device, an infrared channel, a satellite link, a fiber optic link, and a cable link.

11. A method of initializing a symmetric algorithm based public key system, the method comprising the steps of:
a) generating and storing a plurality of client secret key values and identifiers;
b) distributing the plurality of client secret key values and identifiers to respective ones of the plurality of clients;
c) generating and storing a plurality of service provider secret key values and identifiers;
d) distributing the plurality of service provider secret key values and identifiers to respective ones of the plurality of service providers; and
e) generating a plurality of public key values for at least one pairing of the plurality of service providers and the plurality of clients and exclusive of pairings of one service provider with another service provider and one client with another client.

12. A method according to claim 11, further including at least one of the steps of:
receiving a request for on demand generation of a public key value prior to step (e);
storing the plurality of public key values, and providing access to a global public key table containing the plurality of public key values;
generating a service provider public key table for a selected service provider of the plurality of service providers, the service provider public key table containing ones of the plurality of public key values corresponding to the selected service provider and the plurality of clients, and distributing the service provider public key table to the selected service provider; and
generating a client public key table for a selected client of the plurality of clients, the client public key table containing ones of the plurality of public key values corresponding to the selected client and the plurality of service providers, and distributing the client public key table to the selected client.

13. A method according to claim 11, further including at least one of the steps of:
generating a trusted authority secret key value and identifier;
generating a plurality of trusted authority public key values for pairing of the trusted authority and respective ones of the plurality of clients; and
generating a plurality of additional trusted authority public key values for each pairing of the trusted authority and the plurality of service providers respectively.

14. The method according to claim 11, further including the steps of:
receiving a request for authentication of one of the plurality of service providers;
searching at least one of a white list and a black list for the service provider;
responding positively if the service provider is either found on the white list or not found on the black list; and
responding negatively if the service provider is either not found on the white list or found on the black list.

15. A method according to claim 11, further includes authorizing the addition of a new service provider, including the steps of:
generating and storing, by the trusted authority, a new service provider secret key value and identifier;
generating, by the trusted authority, a plurality new service provider public key values for a pairing of the new service provider and respective ones of the plurality of clients; and
distributing, from the trusted authority to the new service provider, the new service provider secret key value and identifier to the new service provider and the plurality of new service provider public key values to the new service provider and to the plurality of clients.

16. A method according to claim 11, further includes invalidating a compromised service provider of the plurality of service providers, including the steps of:
receiving an indication that the compromised service provider has been compromised;
deleting, by the trusted authority, one at least one of the secret key value for the compromised service provider and the service provider identifier for the compromised service provider from a memory; and
deleting, by the trusted authority, one or more public key values corresponding to the compromised service provider from the memory.

17. The method according to claim 16, further including at least one of the steps of:
adding, by the trusted authority, the compromised service provider to a black list of unacceptable service providers;
removing, by the trusted authority, the compromised service provider from a white list of acceptable service providers; and
sending a message from the trusted authority to the plurality of clients to discontinue future communications with the compromised service provider.

18. A method according to claim 11, further includes authorizing the addition of a new client, including the steps of:
generating and storing, by the trusted authority, a new client secret key value and identifier;
generating, by the trusted authority, a plurality of new client public key values for a pairing of the new client and each of the plurality of service providers; and
distributing, from the trusted authority to the new client, the new client identifier and the new client secret key and distributing the new client public key values from the trusted authority to the plurality of service providers, respectively;
generating, by the trusted authority, a new client public key table containing the plurality of new client public key values, and distributing the client new client public key table to the new client.

19. A method of downloading a secure device upgrade encrypted with at least a session key, the method comprising the steps of:
a) receiving a transmission from a service provider including a service provider identifier and an encrypted session key;
b) requesting authentication of the service provider from a trusted authority;
c) receiving an authentication response from the trusted authority;
d) aborting the download if the authentication response is negative and continuing the download if the authentication response is positive;
e) obtaining a public key for decrypting at least a portion of the transmission from the service provider;
f) decrypting the portion of the transmission to obtain a decrypted session key;
g) securing a communications channel to the service provider with the session key; and
h) receiving the device upgrade from the service provider through the secured communications channel.

20. A method according to claim 19, further including the steps of:
receiving a payload hash value;
computing a hash value for the device upgrades;
aborting the download if the payload hash value and the computed hash value do not match; and
continuing the download if the payload hash file and the computed hash value do match.

21. A method according to claim 19, further including the step of generating a log including one or more of the service provider identifier, an identifier for the device upgrades, the date of receiving the transmission, and the payload hash value.

22. A method according to claim 19, further including the step of updating a secret key of a secure communications system using a second secret key by:
receiving a transmission from a trusted authority including a trusted authority identifier and an encrypted session key;
obtaining a public key for decrypting at least a portion of the transmission from the trusted authority;
decrypting the transmission using the public key and the second secret key to obtain a decrypted session key;
receiving a new secret key from the trusted authority, the new secret key being encrypted with at least the session key; and
replacing the secret key with the new secret key.
